(19) United States
(12) Patent Application Publication
(10) Pub. No.: US 2009/0141047 A1
(43) Pub. Date: Jun. 4, 2009

(54) VIRTUAL WORLD COMMUNICATION DISPLAY METHOD

(75) Inventors: Cary Lee Bates, Rochester, MN (US); Jim Chun-Ta Chen, Rochester, MN (US); Zachary A. Garbow, Rochester, MN (US); Gregory E. Young, St. Paul, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/947,002

(22) Filed: Nov. 29, 2007

(51) Int. Cl. G09G 5/00

(52) U.S. Cl. 345/666

(57) ABSTRACT

A method for displaying an instant message within a text box visible to a first avatar in a virtual world is disclosed. The instant message is sent from a second avatar to a third avatar. The method includes determining a distance within the virtual world between the first avatar and at least one of the second avatar and the third avatar, assigning a distance reduction factor to a word of the instant message based upon context of the word, and multiplying the distance by the distance reduction factor to thereby define a logical distance of the word. The logical distance is compared to a threshold value and a display option is selected for the word based upon the comparison. The instant message is displayed within the text box with the word having the selected display option.

### BACKGROUND OF THE INVENTION

1. Field of the Invention

This invention relates to display of communication within online simulated environments.

2. Description of Background

Virtual worlds, such as Second Life, developed by Linden Research, Inc. for example, are simulated environments through which cartoon characters, also known as avatars, navigate and can communicate via instant messages. Typically, non verbal communication consists of text boxes that display the instant messages between avatars that are within a same room or location of the virtual world. However, when a large number of avatars are present within a given location, a large potential number of text boxes, which each represent individual conversations between avatars, can make it difficult to read all the messages on a given amount of screen space.

Present attempts to mitigate this problem include showing only messages from avatars that are within “hearing” distance of each other, and shrinking the size of messages from avatars that are located farther away. However, simply dropping the messages from those avatars that are not in immediate proximity prevents discovery of potentially relevant or important information. While shrinking the size of the messages from avatars in relation to their distance can help conserve screen space, at a certain point the messages become impossible to read. Accordingly, the state of the art may be advanced by an instant message display arrangement that overcomes these drawbacks.

### SUMMARY OF THE INVENTION

An embodiment of the invention includes a method for displaying an instant message within a text box visible to a first avatar in a virtual world. The instant message is sent from a second avatar to a third avatar. The method includes determining a distance within the virtual world between the first avatar and at least one of the second avatar and the third avatar, assigning a distance reduction factor to a word of the instant message based upon context of the word, and multiplying the distance by the distance reduction factor to thereby define a logical distance of the word. The logical distance is compared to a threshold value and a display option is selected for the word based upon the comparison. The instant message is displayed within the text box with the word having the selected display option.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which utilizes a filter for communications between avatars in a virtual world. The filter includes use of the proximity of avatars in conjunction with the content of the communications to control the display of the messages between avatars.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic block diagram of an infrastructure for operation of a communication filter arrangement in accordance with an embodiment of the invention;

FIG. 2 illustrates an instant message text box in accordance with an embodiment of the invention;

FIG. 3 illustrates a flowchart of process steps for assigning a distance reduction factor in accordance with an embodiment of the invention; and

FIG. 4 illustrates a flowchart of process steps for displaying an instant message in accordance with an embodiment of the invention.

The detailed description explains the preferred embodiments of the invention, together with advantages and features, by way of example with reference to the drawings.

### DETAILED DESCRIPTION OF THE INVENTION

An embodiment of the invention reduces space needed to display instant messages between avatars in a same area of a virtual world by emphasizing particular words and omitting less relevant details in conjunction with distance to provide other avatars an awareness of the topic of discussion. A communication filter determines which keywords to display and which to omit, thereby increasing a relevance of the instant message with respect to a viewing avatar.

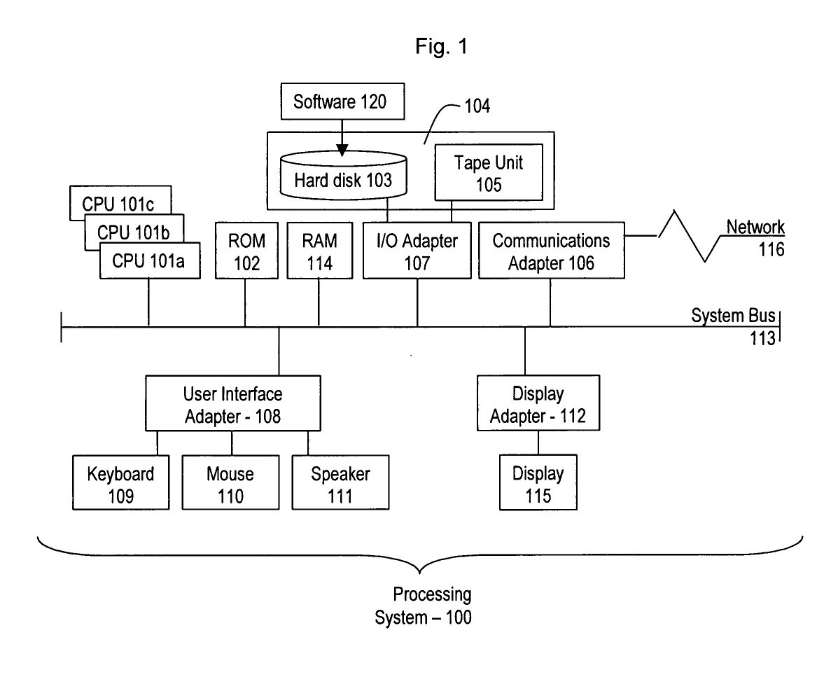

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes the network adapter or interface 106 for communicating over the network 116. The network 116 can be a local-area network (LAN), a metro-area network (MAN), or wide-area network (WAN), such as the Internet or World Wide Web.

Users of the system 100 can connect to the network 116 through any suitable network interface 106 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 103) for capture and interactive display of information shown on the screen 115 of a user. As discussed herein, the instructions are referred to as “software” 120. The software 120 may be produced using software development tools as are known in the art. Also discussed herein, the software 120 may also referred to as “communication filter software” 120 or other similar terms. The software 120 may include various tools and features for controlling the display of the messages between avatars based upon proximity of avatars in conjunction with content of the communications.

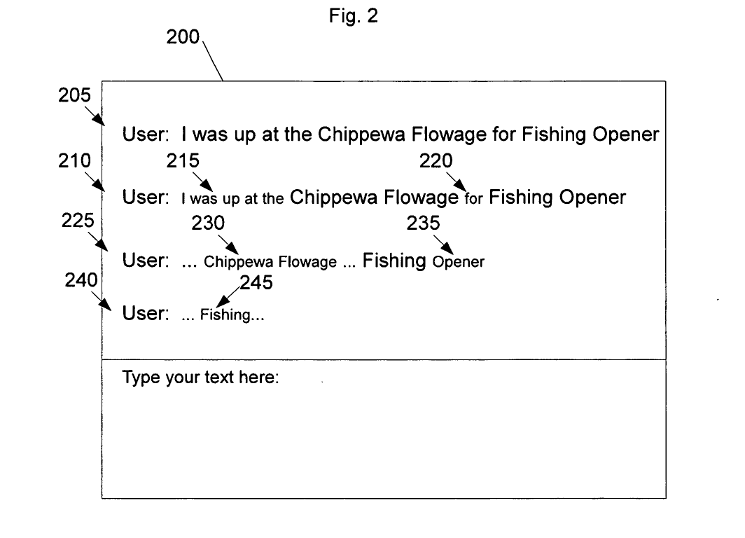

FIG. 2 depicts an embodiment of an Instant Message Text Box 200, as may be perceived by a first avatar viewing a communication by a second avatar directed to a third avatar. The second and third avatars are located at some logical distance in the virtual world from the first avatar, as will be described further below.

For example, reference numeral 205 represents a communication by the second avatar, as perceived by the first avatar, in response to the first avatar being located at a first logical distance, such as very close to the second avatar and/or the third avatar for example. All of the text of the communication 205 is displayed with its original formatting, such as at an original font size, for example.

As another example, reference numeral 210 represents the same communication by the second avatar, as perceived by the first avatar, in response to the first avatar being located at a second logical distance, greater than the first logical distance, from the second avatar and/or the third avatar. All of the text of the communication 210 is displayed, but some of text 215, 220 is displayed at reduced font size to reduce the amount of screen size within the text box 200 that is consumed by the communication 210.

As yet a further example, reference numeral 225 represents the same communication by the second avatar, as perceived by the first avatar, in response to the first avatar being located at a third logical distance, greater than the second logical distance, from the second avatar and/or the third avatar. Only a portion of the text of communication 225 is displayed, with the remainder of the communication 225 being omitted from display. Further, portions of the text 230, 235 are displayed having changed formatting such as reduced font size to further reduce the amount of screen size consumed by the communication 225.

Reference numeral 240 represents yet another example of the same communication by the second avatar that is perceived by the first avatar in response to the first avatar being located at a fourth logical distance, greater than the third logical distance, from the second avatar and/or the third avatar. Only a portion of the text 245 of communication 240 is displayed. Further the text 245 that is displayed has a reduced font size to further reduce the amount of screen size consumed by the communication.

It will be appreciated that communications 205, 210, 225, and 240 are depicted within the same text box 200 of FIG. 2 for the purposes of illustration and comparison, and it is contemplated that in use, the text box 200 would display one of the different communications 205, 210, 225, and 240 as depicted in FIG. 2, in response to determination of the logical distance between the first avatar and at least one of the second avatar and the third avatar.

To facilitate display of the foregoing exemplary communications 205, 210, 225, and 240 within the text box 200, an embodiment includes a filter through which the words of the communication pass to define a distance reduction factor. A product of the distance reduction factor and an actual distance from the first avatar (viewing the communication) to either or both of the second and third avatars (between which the communication occurs) thereby defines the logical distance, which is used as a factor to format the display of the text of the communication within the text box 200. For example, a given actual distance multiplied with a large distance reduction factor yields the logical distance that is less than the given actual distance from the first avatar to either or both of the second and third avatars. It will be appreciated that a large distance reduction factor is represented by a numerically smaller factor or multiplicand that is then multiplied by the given actual distance to define the logical distance. Formatting of the words within the communication will be directly related to the logical distance of each word, as defined by the product of the given actual distance and the distance reduction factor. The greater the logical distance, the smaller the emphasis on the word, such that at one extreme, a word having a large logical distance may be omitted from the display of the communication within the text box 200, for example.

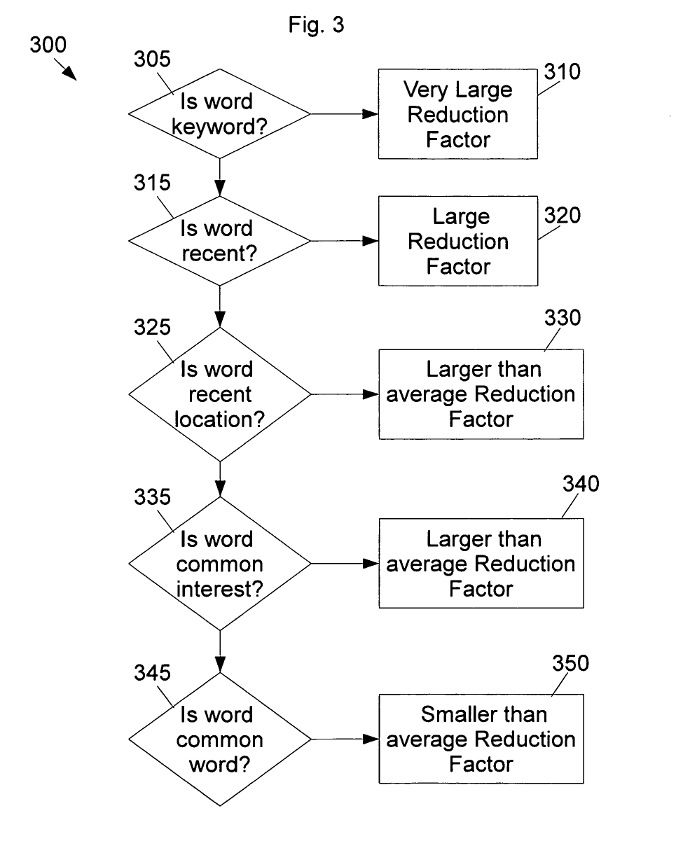

FIG. 3 represents a flow chart 300 of process steps of one embodiment of the filter through which words of the communication pass to define the distance reduction factor. In some embodiments, each word of the communication passes separately through the filter. In other embodiments groups of one or more words pass together through the filter.

At decision block 305, the filter determines if the word is a keyword that is associated (via prior user specification within a table or collection of keywords for example) with the user's (first avatar's) interests. If the word is associated with the first avatar's interests, it is expected that first avatar would be interested with the communication, particularly the word that is associated with the interest. Therefore, in response to determining that the word is a keyword associated with the first avatar's interests, the filter proceeds to block 310, and assigns a very large reduction factor (very small numeric multiplicand) to the word. Accordingly, the logical distance defined by the product of the distance and the distance reduction factor assigned at block 310 relating to the word is much smaller than the actual distance.

If it is determined at decision block 305 that the word (or group of words) is not a keyword (or keywords) associated with the first avatar's interests, the process proceeds to decision block 315, in which the filter determines if the word is a non-common word that has been used by the first avatar in a recent conversation. For example, an instant message that includes the first avatar as either a sender or receiver. For purposes of illustration and not limitation, it will be appreciated that examples of common words include “the”, “a”, “of”, “for”, and similar words. If the word is a non-common word that has been used by the first avatar within a recent conversation, it is expected that the first avatar may be interested with the communication, particularly the non-common word that the first avatar had recently used. Therefore, in response to determining that the word is a non-common word that has been used by the first avatar in a recent conversation, the filter proceeds to block 320, and assigns a large reduction factor, which is smaller than the very large reduction factor assigned in block 310 (therefore having a larger numeric multiplicand). Accordingly, the logical distance defined by the product of the distance and the distance reduction factor assigned at block 320 is smaller than the actual distance, but larger than the logical distance defined in conjunction with the very large reduction factor assigned in block 310.

If it is determined at decision block 315 that the word (or group of words) is not a non-common word that has been used by the first avatar in a recent conversation, the process proceeds to decision block 325, in which the filter determines if the word matches a keyword that is associated with a location that the first avatar has recently visited, such as via comparison with locations stored within a table or history of recently visited locations, for example. If the word matches a keyword that is associated with a location that the first avatar has recently visited, it is expected that the first avatar may be interested in the communication, particularly with respect to the location that the first avatar has recently visited. Therefore, in response to determining that the word matches a keyword that is associated with a location that the first avatar has recently visited, the filter proceeds to block 330, and assigns a larger than average reduction factor, which is smaller than the large reduction factor assigned in block 320 (and therefore has a larger numeric multiplicand). Accordingly, the logical distance, as defined by the product of the distance and the distance reduction factor assigned at block 330 is smaller than the actual distance, but larger than the logical distance defined in conjunction with the reduction factors assigned at blocks 310 and 320.

If it is determined at decision block 325 that the word (or group of words) does not match a keyword that is associated with a location that the first avatar has recently visited, the process proceeds to decision block 335, in which the filter determines if the word is of interest to other avatars with whom the first avatar has recently communicated via an instant message, such as by comparison with keywords of interest to other avatars that may be stored within a table of keywords of interest of avatars with whom the first avatar has communicated within a given period of time or conversation history, for example. If the word matches a keyword that is of interest to other avatars with whom the first avatar has recently communicated, it is expected that the first avatar may be interested in the communication, particularly with respect to the keyword of interest. Therefore, in response to determining that the word matches the keyword that is of interest to the other avatars, the filter proceeds to block 340, and assigns a larger than average reduction factor, which is smaller than the large reduction factor assigned in block 320 (therefore having a larger numeric multiplicand). Accordingly, the logical distance, as defined by the product of the distance and the distance reduction factor assigned at block 340 is smaller than the actual distance but larger than the logical distance defined in conjunction with the reduction factors assigned at blocks 310, 320, and 330.

If it is determined at decision block 335 that the word (or group of words) does not match a word of interest to other avatars with whom the first avatar has recently communicated, the process proceeds to decision block 345, in which the filter determines if the word is a common word, such as via comparison with a table of words that are designated as common words. If the word matches a word that is designated as a common word, it is expected that the first avatar may not be particularly interested in the common word. Therefore, in response to determining that the word is a common word, the filter proceeds to block 350, and assigns a smaller than average reduction factor, which is smaller than the larger than average reduction factor assigned in blocks 330 and 340 (and therefore has a larger numeric multiplicand). Accordingly, the logical distance, as defined by the product of the distance and the distance reduction factor assigned at block 350 may be greater than the actual distance, and thereby lead to a de-emphasis (such as by reducing font size for example) of the word. Further, if the logical distance is great enough, complete removal of the common word from the display of the communication within the text box 200 may result.

The communication filter software 120 calculates the logical distance for each word within the communication based on the distance multiplied by the reduction factor, as described above. The greater the logical distance, the less emphasis the word will receive within the text box 200. The rules may be applied in the order described above, such that the reduction factor assigned in response to the first one of the decision blocks 305, 315, 325, 335, and 345 shall be the controlling reduction factor for use in calculating the logical distance for the word.

In an embodiment, thresholds relating to the logical distance may be established. For example, formatting of words having a logical distance below a first threshold may be unchanged, while words having a logical distance greater than the first threshold, but below a second threshold, may have their formatting changed, such as to have their font size reduced. Further, words having a logical distance greater than the second threshold may be omitted altogether from the communication within the text box 200.

In another embodiment, a concentration of avatars within a given location affects the calculation of the reduction factor. For example, if there are relatively few avatars proximate the first avatar, the filter software 120 can be less aggressive with respect to the calculation of the reduction factor. That is, in response to the first avatar being present in a location with few other avatars, the reduction factor assigned by process blocks 310, 320, 330, 340, and 350 can be larger than the reduction factor that would otherwise be calculated if there were a greater number of avatars present in the location, thereby decreasing the logical distance such that an amount of text elimination or change of formatting is reduced. Alternatively, if the first avatar is in a crowded location, such as a mall or sports stadium for example, the filter software 120 can be more aggressive with respect to the calculation of the reduction factor. That is, in response to the first avatar being present in a location with many other avatars, the reduction factor assigned by process blocks 310, 320, 330, 340, and 350 can be smaller than the reduction factor that would otherwise be calculated if there were a fewer number of avatars present in the location, thereby increasing the logical distance such that an amount of text elimination or change of formatting is increased.

In a further embodiment, the filter software 120 is responsive to a screen size upon which the text box 200 is displayed. For example, in response to display of the text box 200 upon a small size screen, such as a personal digital assistant (PDA), cellphone, or small laptop for example, the filter software 120 is more aggressive with respect to calculation of the reduction factor, thereby increasing the logical distance such that an amount of text elimination or formatting change is increased in order to conserve use of space of the small size screen of the device.

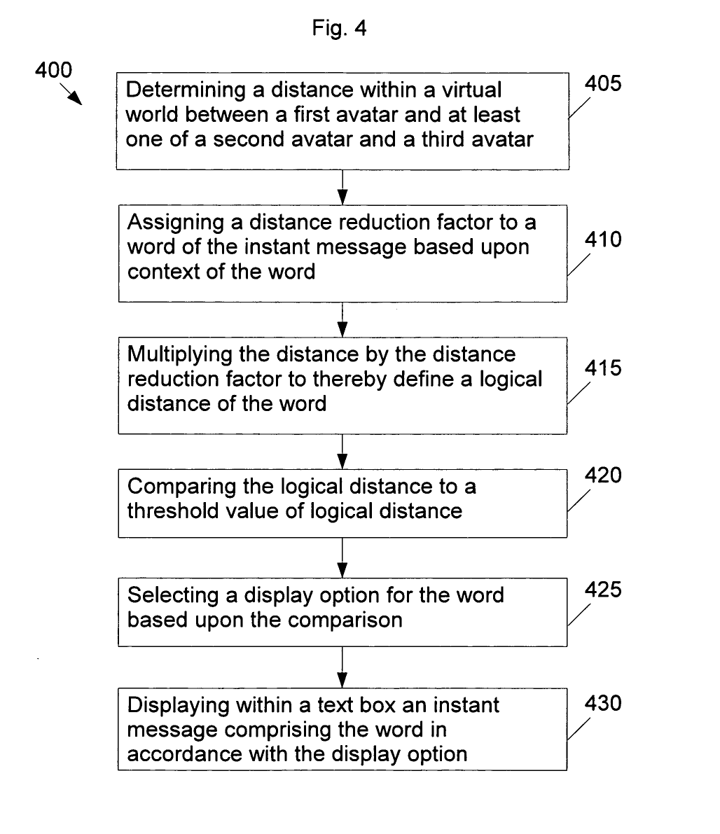

In view of the foregoing, the filter software 120 facilitates a method to display an instant message within the text box 200 visible to a first avatar in the virtual world, such as the instant message sent from the second avatar to the third avatar. FIG. 4 depicts a flowchart 400 of process steps of an embodiment of the method.

The method begins at step 405 by determining a distance within the virtual world between the first avatar and at least one of the second avatar and the third avatar. At step 410, the method proceeds by assigning the distance reduction factor to a word of the instant message based upon context of the word. At step 415, the method includes multiplying the distance by the distance reduction factor to thereby define the logical distance of the word. At step 420, the method includes comparing the logical distance to a threshold value of logical distance. Step 430 includes selecting a display option for the word based upon the comparison, in step 420, of the defined logical distance to the threshold value. The method concludes at step 440 with displaying within the text box 200 the instant message, with the word displayed in accordance with the display option selected at step 430.

In an embodiment, the assigning the distance reduction factor at step 410 includes assigning the distance reduction factor based upon at least one of a word associated with an interest of the first avatar, a non-common word used within an instant message that includes the first avatar as at least one of a sender and a receiver, a word corresponding to a virtual world location visited by the first avatar, a word associated with an interest of an avatar to which the first avatar has communicated via a prior instant message, and a word that is a common word, such as “the”, “a”, “of”, “for”, and similar words for example.

In an embodiment, the selecting a display option at step 425 includes selecting an original format of the word (to leave the word in its original format) in response to the logical distance of the word being less than a first threshold value. Additionally, in response to the logical distance being greater than the first threshold value and less than a second threshold value, the method includes selecting a reduced font size of the word. Further, in response to the logical distance being greater than the second threshold value, the method includes selecting to omit the word from the instant message.

In another embodiment, in response to the first avatar being present at a virtual world location with relatively few other avatars proximate the first avatar, such as a number of other avatars that is less than a first threshold, the method further includes decreasing the logical distance defined at Step 415. Alternatively, in response to the first avatar being present at a crowded virtual world location, such as proximate a number of other avatars that is greater than a second threshold, the method further includes increasing the logical distance defined at Step 415.

In another embodiment, the filter software is responsive to the screen size upon which the text box 200 is displayed, such that in response to the text box 200 being displayed upon a display 115 having a size less than a threshold size, the method includes increasing the logical distance defined at step 415, thereby reducing an amount of space consumed by display of the instant message.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for displaying an instant message within a text box visible to a first avatar in a virtual world, the instant message sent from a second avatar to a third avatar, the method comprising:
determining a distance within the virtual world between the first avatar and at least one of the second avatar and the third avatar;
assigning a distance reduction factor to a word of the instant message based upon context of the word;
multiplying the distance by the distance reduction factor to thereby define a logical distance of the word;
comparing the logical distance to a threshold value of logical distance;
selecting a display option for the word based upon the comparison; and
displaying within the text box the instant message comprising the word in accordance with the display option.

2. The method of claim 1, wherein the assigning comprises assigning a distance reduction factor based upon at least one of:
a word associated with an interest of the first avatar;
a non-common word used within an instant message including the first avatar;
a word corresponding to a virtual world location visited by the first avatar;
a word associated with an interest of an avatar to which the first avatar has communicated; and
a word that is a common word.

3. The method of claim 1, wherein the selecting comprises:
in response to the logical distance of the word being less than a first threshold value, selecting an original format of the word;
in response to the logical distance being greater than the first threshold value and less than a second threshold value, selecting a reduced font size of the word; and
in response to the logical distance being greater than the second threshold value, selecting to omit the word from the instant message.

4. The method of claim 1, further comprising:
in response to the first avatar being present at a virtual world location with a number of other avatars that is less than a first threshold, decreasing the defined logical distance; and
in response to the first avatar being present at a virtual world location with a number of other avatars that is greater than a second threshold, increasing the defined logical distance.

5. The method of claim 1, further comprising:
in response to the text box being displayed upon a display having a size less than a threshold size, increasing the defined logical distance.
